(19) United States
(12) Patent Application Publication
(10) Pub. No.: US 2007/0125612 A1
(43) Pub. Date: Jun. 7, 2007

(54) DUST COVER AND SHOCK ABSORBER HAVING THE SAME

(75) Inventors: Myung Hwa Hyun, Suwon-si (KR); Eun Pyo Hong, Seoul (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MANDO CORPORATION, Seoul (KR)

(21) Appl. No.: 11/565,664

(22) Filed: Dec. 1, 2006

(30) Foreign Application Priority Data
Dec. 2, 2005 (KR) 10-2005-0116975

(51) Int. Cl. F16F 9/38

(52) U.S. Cl. 188/322.12

(57) ABSTRACT

A dust cover partially encloses a piston rod and a cylinder of a shock absorber to prevent foreign materials from being introduced into the cylinder via the piston rod. The dust cover includes at least two covers configured to be separated vertically and have ends overlapping with and sliding on each other. A gap between the two covers is defined to be directed upward.

### BACKGROUND OF THE INVENTION

The present invention relates to a dust cover and a shock absorber having the same, and more particularly, to a dust cover formed to enclose a cylinder and a piston rod of a shock absorber to prevent foreign materials from being introduced into the cylinder from the outside, and a shock absorber having the same.

A shock absorber, which serves to support the weight of a vehicle body and at the same time to suppress and attenuate a vibration transferred from a road to the vehicle body, is one of main components of a vehicle suspension system. Such a shock absorber absorbs and then relieves vertical vibration energy of a road wheel generated from unevenness of a road or the like, thereby preventing the vibration from being directly transferred to the vehicle body. Accordingly, the shock absorber contributes to improved ride comfort of a passenger and to protection of loaded freight and parts of the vehicle.

Such a shock absorber includes a cylinder and a piston rod slidably accommodated in the cylinder. The cylinder is connected to a road wheel through a suspension arm and the like, and the piston rod is connected to a vehicle body side, wherein a piston valve is connected to a lower end of the piston rod. Accordingly, when a vehicle runs on an uneven road, the shock absorber serves to suppress and attenuate the vibrations transferred from the road to the vehicle body while compression and rebound strokes are continuously repeated.

The general shock absorber further includes a dust cover partially enclosing the piston rod and the cylinder in order to prevent foreign materials from being introduced into the cylinder through the piston rod.

FIG. 1 is a partial sectional view showing that a conventional dust cover is installed to a shock absorber 10. Referring to FIG. 1, in the conventional shock absorber 10, a piston rod 13 is fitted and inserted into a side of a cylinder 12.

A dust cover 11, which is installed so as to partially enclose upper sides of the piston rod 13 and the cylinder 12 into which a side of the piston rod 13 is inserted, is configured to have an upper side fixed to the upper end of the piston rod 13 and closed and a lower side opened. When the piston rod 13 is retracted and extended, it is noted that an inner surface of the dust cover 11 slides on an outer surface of the upper side of the cylinder 12, so that external foreign materials are prevented from contaminating the inside of the cylinder 12 and the piston rod 13.

However, during the rebound stroke, the conventional dust cover 11 slides upward relative to the cylinder 12 and thus a negative pressure is generated in the conventional dust cover 11 with the lower side opened, so that external air is introduced from below between the lower side of the dust cover 11 and the cylinder 12. Accordingly, there is a problem in that large amounts of foreign materials are introduced from a road into the cylinder.

On the other hand, although not shown, a bellows type dust cover, which is installed to fix both upper and lower ends of a cylinder, is repeatedly contracted and expanded while a piston rod repeatedly is retracted and extended, thereby causing a problem that the dust cover is worn away as well as noise is generated when the dust cover is contracted and expanded.

### SUMMARY OF THE INVENTION

An embodiment of the present invention provides a dust cover for preventing external air from being introduced into the dust cover from below during a rebound stroke, and a shock absorber having the same.

In one embodiment, a dust cover is configured to partially enclose a piston rod and a cylinder of a shock absorber to prevent foreign materials from being introduced into the cylinder via the piston rod. The dust cover comprises two covers configured to be separated up and down and to have ends overlapping with and sliding on each other, wherein a gap between the two covers is defined to be directed upward.

### BRIEF DESCRIPTION OF THE DRAWINGS

FIG. 1 is a view showing a shock absorber according to a prior art;

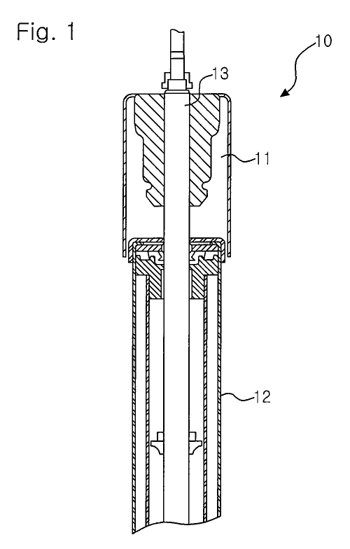

FIG. 2 is a view showing that a shock absorber according to the present invention is in a rebound stroke; and

FIG. 3 is a view showing that the shock absorber according to the present invention is in a compression stroke.

### DETAILED DESCRIPTION OF THE PREFERRED EMBODIMENT

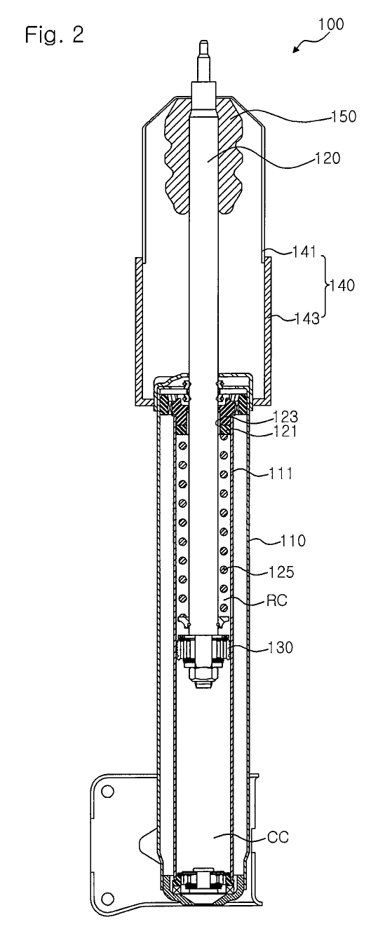

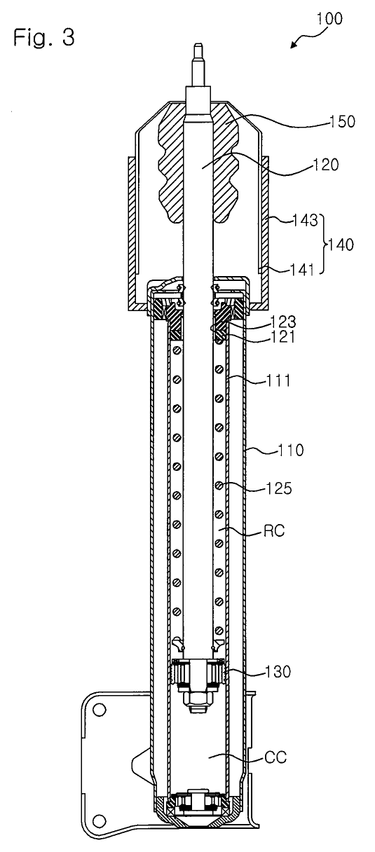

FIG. 2 is a view showing that a shock absorber according to the present invention is in a rebound stroke, and FIG. 3 is a view showing that the shock absorber according to the present invention is in a compression stroke.

As shown in the figures, a shock absorber 100 according to the present invention includes a cylinder 110, a piston rod 120, a piston 130, and a dust cover 140 partially enclosing upper sides of the piston rod 120 and the cylinder 110.

An inner cylinder 111 is installed in the cylinder 110. The inner cylinder 111 is filled with working fluid, i.e., hydraulic oil, and fluid for compensating an internal pressure of the inner cylinder 111 is filled outside the inner cylinder 111, i.e., between the inner cylinder 111 and the cylinder 110. Then, the piston 130 connected to the piston rod 120 is reciprocatingly movably installed to the inner cylinder 111 of the cylinder 110 while partitioning the interior of the inner cylinder 111 into a compression chamber CC and a rebound chamber RC.

The piston rod 120 is installed such that a side thereof is inserted into the inner cylinder 111 and the other side thereof protrudes out of the cylinder 110. A rod guide 121 is installed between the piston rod 120 and the cylinder 110. A through hole 123 is formed in the center of the rod guide 121, and the piston rod 120 is inserted through the through hole 123. The rod guide 121 seals between the cylinder 110, the inner cylinder 111, and the piston rod 120. A coil spring 125 is installed around the piston rod 120. The coil spring 125 is extended and compressed when the piston rod 120 moves upward and downward.

A bumper stopper 150 is installed between the cylinder 110 into which the piston rod 120 is inserted and the piston rod 120, and thus, absorbs the shock load transferred from a road wheel to a vehicle body when the piston rod 120 is retracted and extended.

The dust cover 140 comprises an upper cover 141 and a lower cover 143. The upper cover 141 is installed to be fixed to the upper end of the piston rod 120 and to enclose the bumper stopper 150 and a portion of the piston rod 120. The lower cover 143 is installed to be fixed to the upper end of the cylinder 110 and to partially enclose the piston rod 120 inserted into the cylinder 110. Here, the upper cover 141 has a lower side opened, while the lower cover 143 has an upper side opened. In addition, the lower cover 143 is configured to have an inner diameter larger than that of the upper cover 141, so that when the piston rod 120 is retracted and extended, the lower end of the upper cover 141 is inserted into the upper end of the lower cover 143 and thus the outer surface of the upper cover 141 can slide on the inner surface of the lower cover 143.

When the shock absorber 100 so configured is in the rebound stroke in which the vehicle body becomes more distant from a road in a vehicle driving state, as shown in FIG. 2, the fluid moves toward the compression chamber CC and thus the piston valve 130 moves upward in the cylinder 110, so that the piston rod 120 protrudes out of the cylinder 110. Therefore, while being maintained to be inserted in the lower cover 143, the upper cover 141 protrudes from the lower cover 143 by the stroke of the shock absorber 100. At this time, since the upper side of the piston rod 120 is enclosed by the upper cover 141 and the upper end of the cylinder 110 into which the piston rod 120 is inserted is enclosed by the lower cover 143, foreign materials are prevented from being introduced into the shock absorber 100. Particularly, such a dust cover 140 is formed so that the inner diameter of the lower cover 143 is larger than that of the upper cover 141, and thus, is configured so that the inner surface of the upper cover 141 can slide on the outer surface of the lower cover 143. Therefore, since air is introduced from above to between the upper cover 141 and the lower cover 143 although the upper cover 141 slides upward relative to the lower cover 143 during the rebound stroke and a negative pressure is generated in the upper cover 141 and the lower cover 143, amounts of the foreign materials introduced into the dust cover 140 from a road will be considerably reduced.

In the meantime, during the compression stroke in which the vehicle body comes up to a road in a vehicle driving state, as shown in FIG. 3, the fluid moves toward the rebound chamber RC and thus the piston valve 130 moves downward in the cylinder 110, so that the piston rod 120 enters the cylinder 110. Therefore, the distance between the upper cover 141 and the lower cover 143 is reduced, and then, the upper cover 141 is inserted into the lower cover 143. Therefore, even though the vehicle body comes up to a road, the foreign materials can be prevented from being introduced into the cylinder 110 or the piston rod 120 of the shock absorber 100.

According to the present invention, since the dust cover is configured such that external air is prevented from being introduced into the dust cover from below during a rebound stroke, there is an advantage in that amounts of foreign materials introduced into the dust cover from a road are considerably reduced.

The aforementioned embodiment is only an example for embodying the present invention. The scope of the present invention is not limited to the embodiment described and illustrated above. The true scope of the present invention should be defined to the extent that those skilled in the art can make various modifications and changes thereto without departing from the scope of the invention as defined by the appended claims.

What is claimed is:

1. A dust cover for partially enclosing a piston rod and a cylinder of a shock absorber to prevent foreign materials from being introduced into the cylinder via the piston rod, the dust cover comprising:
at least two covers configured to be separated vertically and have ends overlapping with and sliding on each other,
wherein a gap between the two covers is defined to be directed upward.

2. The dust cover as claimed in claim 1, wherein the two covers comprise:
an upper cover fixed to an upper end of the piston rod, the upper cover having a lower side configured to be opened; and
a lower cover fixed to an upper end of the cylinder, the lower cover having an upper side configured to be opened.

3. The dust cover as claimed in claim 2, wherein the upper and lower covers are configured so that a lower end of the upper cover is inserted into an upper end of the lower cover and an outer surface of the upper cover slides on an inner surface of the lower cover.

4. The dust cover as claimed in claim 2, wherein an inner diameter of the lower cover is larger than an outer diameter of the upper cover.

5. A shock absorber, comprising:
a dust cover for partially enclosing a piston rod and a cylinder of a shock absorber to prevent foreign materials from being introduced into the cylinder via the piston rod,
wherein the dust cover comprises at least two covers configured to be separated vertically and have ends overlapping with and sliding on each other,
wherein a gap between the two covers is defined to be directed upward.

6. The shock absorber of claim 5, wherein the two covers comprise:
an upper cover fixed to an upper end of the piston rod, the upper cover having a lower side configured to be opened; and
a lower cover fixed to an upper end of the cylinder, the lower cover having an upper side configured to be opened.

7. The shock absorber of claim 6, wherein the upper and lower covers are configured so that a lower end of the upper cover is inserted into an upper end of the lower cover and an outer surface of the upper cover slides on an inner surface of the lower cover.

8. The shock absorber of claim 6, wherein an inner diameter of the lower cover is larger than an outer diameter of the upper cover.
